(19) United States
(12) Patent Application Publication
(10) Pub. No.: US 2025/0289508 A1
(43) Pub. Date: Sep. 18, 2025

(54) PICKUP VEHICLE WITH LOWER VEHICLE BODY HAVING DRAINAGE STRUCTURE FOR PROTECTING POWER ELECTRONICS SYSTEM

(71) Applicants: Hyundai Motor Company, Seoul (KR); Kia Corporation, Seoul (KR)

(72) Inventor: Deok-Hwa Hong, Hwaseong-si (KR)

(21) Appl. No.: 18/938,795

(22) Filed: Nov. 6, 2024

(30) Foreign Application Priority Data
Mar. 14, 2024 (KR) 10-2024-0035636

(51) Int. Cl. B62D 25/20

(52) U.S. Cl. CPC B62D 25/2054

(57) ABSTRACT

A lower vehicle body having a drainage structure for protecting a PE system applied to a pickup vehicle can include a PE convex part of a rear floor panel forming a bed floor lower space with the bed floor and forms the periphery of a PE system as a drainage protection area, such as by using a water blocking wall, thereby preventing water from draining to a top portion of the PE system, in particular, and preventing water from stagnating at a corner portion by a drainage protection area and a drainage guide area due to the prevention of the water drainage to the top portion of the PE system and preventing water from flowing into the indoor and stagnating in the rear floor panel due to the water drainage to a lower end and sides of the bed floor by the drainage area.

### CROSS-REFERENCE TO RELATED APPLICATIONS

This application claims the benefit of Korean Patent Application No. 10-2024-0035636, filed on Mar. 14, 2024, which application is hereby incorporated herein by reference.

### TECHNICAL FIELD

The present disclosure relates to a pickup vehicle having a drainage structure of a bed floor.

### BACKGROUND

In general, a pickup vehicle includes a cabin of a driver's seat, which is an indoor space, and a deck of a loading box, which is an outdoor space in which cargo may be loaded and transported, and recently, has been expanded to electric vehicles, and thus a wide variety of an electric vehicle (EV) pickup vehicles are being commercialized.

For example, in the EV pickup vehicle, with respect to a rear floor panel of a vehicle body, a power electronics (PE) system is located at a lower end of a rear floor panel of the vehicle body, and a bed floor is added to an upper end of the rear floor panel. In this case, the PE system is a rear (RR) PE system, and the bed floor adopts a sheet molding compound (SMC) bed floor to secure pickup marketability.

Because the EV pickup vehicle has the rear floor panel together with the bed floor, a drainage hole for drainage is applied, and the drainage hole is drilled at front and rear locations of the rear floor panel to form a lower vehicle body drainage structure.

Therefore, the EV pickup vehicle may discharge accumulated water in the cargo space of the deck to the ground through the drainage hole of the rear floor panel.

However, the lower vehicle body having a drainage structure applied to the EV pickup vehicle adopts a drainage hole location that does not consider the location of the PE system located at the lower end of the rear floor panel, and such an indiscriminate drainage hole location causes a drainage path to be located at a top portion of the PE system, thereby causing serious safety issues of the PE system due to drainage.

In addition, even when the drainage hole location avoids the PE system, when the drainage hole is applied to an inappropriate nearby shape, water may stagnate in the deck or water may flow into the indoor (i.e., the cabin).

### SUMMARY

The present disclosure relates to a pickup vehicle, and more particularly, to a pickup vehicle in which a lower vehicle body having a drainage structure of a bed floor and a rear floor panel prevents water from draining to a top portion of a PE system.

Therefore, an embodiment of the present disclosure considering such a point can be directed to providing a pickup vehicle to which a lower vehicle body having a drainage structure for protecting a PE system is applied, in which a drainage protection area for the PE system is set on a rear floor panel on which a bed floor is formed, thereby preventing water from draining to a top portion of the PE system, in particular, preventing water from stagnating at a corner portion by a drainage protection area and a drainage guide area due to the prevention of the water drainage to the top portion of the PE system and preventing water from flowing into the indoor and stagnating in the rear floor panel due to the water drainage to a lower end and sides of the bed floor by the drainage area.

An embodiment of the present disclosure can include lower vehicle body having a drainage structure for protecting a power electronics (PE) system for achieving the object includes a rear floor panel, a bed floor added to an upper end of the rear floor panel to form a bed floor lower space, and a PE convex part forming the periphery of the PE system located under the rear floor panel as a drainage protection area using a water blocking wall, where the water blocking wall moves water of the PE convex part to a drainage area of the rear floor panel at a protruding height higher than the drainage area.

In an embodiment of the present disclosure, the water blocking wall may be an edge forming a height of the PE convex part, three surfaces of four surfaces of the edge may be formed as a convex part edge inclined surface and directed to the front of the PE system, and the remaining one surface can be formed as a convex part rear inclined surface and directed to the rear of the PE system.

In an embodiment of the present disclosure, the rear floor panel may have a drainage hole formed in the drainage area so that the water drains to the outside of the rear floor panel.

In an embodiment of the present disclosure, the rear floor panel may divide the drainage area into a front drainage area formed on the PE mounting part and a rear drainage area formed on the rear portion with respect to the PE convex part.

In an embodiment of the present disclosure, the rear floor panel may move the water by forming an extension surface having a downward inclined structure connected to the PE mounting part on a connection part connected to the PE mounting part.

In an embodiment of the present disclosure, the rear floor panel may form the extension surface and the rear portion together with a surrounding section of the PE convex part as a drainage guide area, and the front inclined structures and the rear inclined structure may be applied to the drainage guide area so that the water moves to the drainage guide area through downward inclination.

In an embodiment of the present disclosure, the front inclined structures may be formed as the extension surface of the connection part connected to the PE mounting part and the convex part edge inclined surface of the PE convex part, and the rear inclined structure may be formed as the convex part rear inclined surface of the PE convex part connected to a third drainage hole formed in the rear portion of the drainage hole.

In an embodiment of the present disclosure, the rear floor panel may be coupled to a rear floor member surrounding side portions of the rear floor panel under the rear floor panel, an upper member located at an upper end of the rear floor panel, and a quarter panel connected to a side portion of the rear floor member on a side surface of the rear floor panel, intersections at which the rear floor member, the upper member, and the quarter panel meet form inclined surfaces at a higher location than the rear floor panel, and the inclined surface may form a water movement path through which the water is collected to the drainage area.

In an embodiment of the present disclosure, the water movement path may be connected to a sidewall upper extension extending from the side flange of the rear floor panel added to a longitudinal member of the rear floor member, and the sidewall upper extension may be located on a longitudinal member side upper end surface of the rear floor member and a transverse member side upper member lower extension of the upper member.

In an embodiment of the present disclosure, the rear floor panel may change the drainage area using any one of a location and shape of the drainage hole and the number of drainage holes through which the water is discharged to the outside, due to an increase in the number of drainage holes, the entire section of the drainage area may be filled with the drainage hole, and due to a modification of a shape of the drainage hole, the entire section of the drainage area may be removed and formed as the drainage hole.

In an embodiment of the present disclosure, a pickup vehicle to which a lower vehicle body having a drainage structure for protecting a power electronics (PE) system can include: a lower vehicle body composed of a rear floor panel on which the PE system is located on a PE block part, a rear floor member surrounding side portions of the rear floor panel, an upper member located at an upper end of the rear floor panel, a quarter panel connected to a side portion of the rear floor member, and a bed floor forming a bed floor lower space with the rear floor panel, a cabin that is an indoor space; and a deck that is an outdoor space forming a deck floor with the bed floor, where a drainage guide area in a surrounding section and a drainage area in a front-rear section are set with respect to the drainage protection area B of the PE convex part in the rear floor panel, an inclined surface can be formed at an intersection at which the upper member and the quarter panel meet in the rear floor member, and the inclined surface can be a movement path through which water introduced through the quarter panel is guided from the intersection to the drainage area.

In an embodiment of the present disclosure, a plurality of drainage holes in which any one of a location, a shape, and a number can be changed may be formed in the drainage area.

In an embodiment of the present disclosure, the rear floor panel and the upper member may separate the cabin and the deck.

In an embodiment of the present disclosure, the quarter panel may be coupled to a bed side trim covering side portions thereof, and the water may flow into a sidewall gap of the quarter panel and the bed side trim.

In the pickup vehicle, in particular, the pickup electric vehicle according to an embodiment of the present disclosure, the lower vehicle body having the drainage structure for protecting the PE system can be applied to prevent the drainage to the RR PE in the EV pickup vehicle, thereby increasing vehicle safety, and in particular, it can be possible to improve the drainage performance of the vehicle body through the smooth drainage of the lower end of the bed floor, thereby preventing water from flowing into the indoor and preventing water from stagnating in the rear floor panel of the vehicle body and thus also improving the corrosion performance of the vehicle body.

### BRIEF DESCRIPTION OF THE DRAWINGS

FIG. 1 is a configuration diagram of a lower vehicle body having a drainage structure for protecting a PE system according to an embodiment of the present disclosure.

FIG. 2 is an example of a water movement path in the lower vehicle body according to an embodiment of the present invention.

FIG. 3 shows a water movement state in the drainage structure for protecting the PE system applied to the lower vehicle body according to an embodiment of the present invention.

FIG. 4 is an example in which a drainage protection area is set in a rear floor panel according to an embodiment of the present invention.

FIG. 5 is a deformed state of the rear floor panel through a drainage hole according to an embodiment of the present invention.

FIG. 6 is a pickup vehicle to which the lower vehicle body having the drainage structure for protecting the PE system according to an embodiment of the present invention is applied.

FIG. 7 shows a water drainage state using the drainage structure for protecting the PE system in the pickup vehicle to which the lower vehicle body according to an embodiment of the present invention is applied.

### DETAILED DESCRIPTION OF ILLUSTRATIVE EMBODIMENTS

Hereinafter, example embodiments of the present disclosure will be described in detail with reference to the accompanying drawings, and these embodiments are examples and can be implemented in various different forms by those skilled in the art to which the present disclosure pertains, and thus are not necessarily limited to example embodiments disclosed herein.

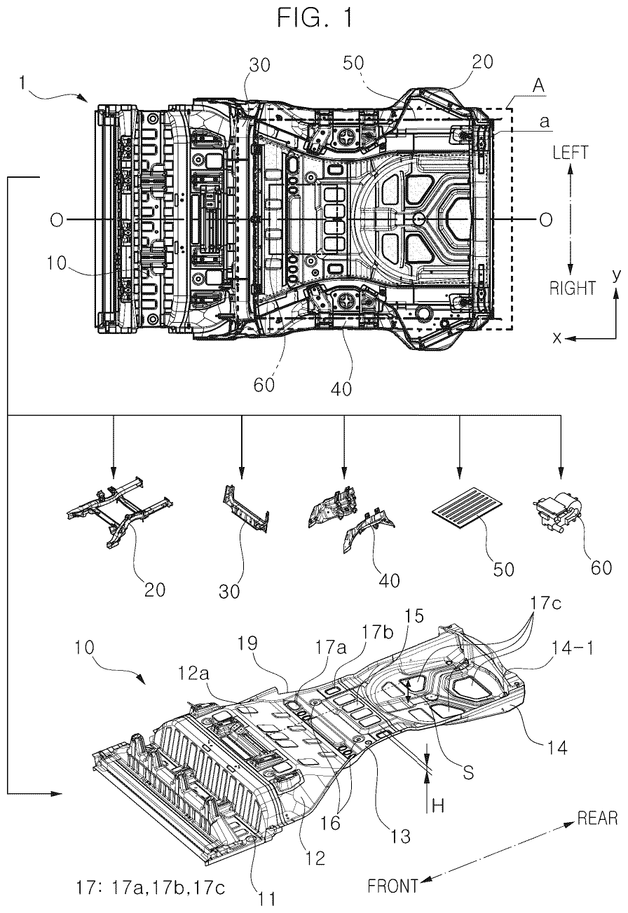

Referring to FIG. 1, a lower vehicle body 1 has a left-right symmetrical structure with respect to a lower vehicle body center line O-O and includes a rear floor panel 10, a rear floor member 20, an upper member 30, a quarter panel 40, and a bed floor 50.

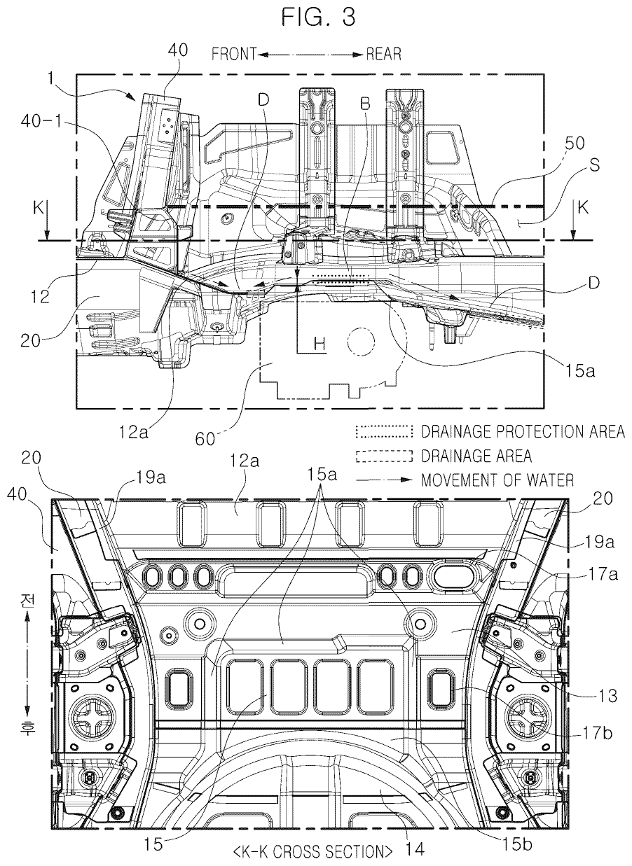

In particular, the rear floor panel 10 can set a PE convex part 15, which can be a location at which a PE system 60 is mounted, as a drainage protection area B (see FIG. 3) to exclude the PE convex part 15 from a movement path of drained water, and thus the lower vehicle body 1 can be characterized by a PE system protection drainage structure type lower vehicle body 1.

Specifically, in terms of the layout of the lower vehicle body 1, the arrangement of the other components 20, 30, 40, and 50 based on the rear floor panel 10 can be as follows.

For example, the rear floor member 20 can be located under the rear floor panel 10 to surround a connection part 12, a PE mounting part 13, and a rear portion 14 excluding a front portion 11 of the rear floor panel 10, and the upper member 30 can be located at an upper end of the rear floor panel 10 to cross the connection part 12 connected from the front portion 11 of the rear floor panel 10.

The quarter panel 40 can be connected to a side portion of the rear floor member 20 on a side surface of the rear floor member 20, and the bed floor 50 can be located at the upper end of the rear floor panel 10 to cover the connection part 12, the PE mounting part 13, and the rear portion 14 excluding the front portion 11 of the rear floor panel 10.

In particular, the bed floor 50 can have a flat structure that covers the upper surface of the rear floor panel 10 to allow cargo to be loaded. The bed floor can be a sheet molding compound (SMC) bed floor for securing pickup marketability.

In addition, the PE system 60 can be located under the rear floor panel 10 and the rear floor member 20 and can be protected by the PE mounting part 13 at the connection part 12 of the rear floor panel 10. The PE system can be a rear (RR) PE system.

Therefore, the lower vehicle body 1 can use a width of the upper member 30 or an inner space of the quarter panel 40 as an expected flooding area “A”, and a drainage hole applicable area “a” can be set in a section of the PE mounting part 13 and the rear portion 14 excluding the front portion 11 of the rear floor panel 10 and the connection part 12.

Specifically, in terms of the configuration of the lower vehicle body 1, the structures and shapes of the rear floor panel 10, the rear floor member 20, the upper member 30, the quarter panel 40, and the bed floor 50 can be as follows.

For example, the rear floor panel 10 can have a substantially rectangular plate shape and can be composed of a plurality of panel components having a height difference in a longitudinal direction, and the connection part 12 and the PE mounting part 13 can be formed by using a space between the front portion 11 and the rear portion 14 that partitions front and rear directions as a middle section.

In particular, the connection part 12 can be connected to the PE mounting part 13 with an extension surface 12a having a downward inclined structure so that the PE mounting part 13 and the rear portion 14 can have a height difference with respect to the front portion 11, and the PE mounting part 13 can be formed with the PE convex part 15 of a water blocking wall H to locate the PE system 60, and a PE mounting hole 16 can be drilled in front of the PE convex part 15 to allow the PE system 60 to be fastened by bolts. Two PE mounting holes 16 can be formed at an interval, but if necessary/desired, three or more PE mounting holes may be formed.

The rear portion 14 can be formed with a perpendicular rear flange 14-1 having the size of the width of the rear portion at an end thereof to support one end of the bed floor 50 to form a bed floor lower space S (see FIG. 3).

The rear floor panel 10 can be formed with a side flange 19 perpendicular to the side surfaces of the connection part 12 (i.e., the extension surface 12a), the PE mounting part 13, and the rear portion 14 and thus easily fixed to the rear floor member 20 by welding.

Therefore, the rear floor panel 10 can have a downward inclined structure of the extension surface 12a of the connection part 12 located in the rear area of the upper member 30 to move water to the drainage hole applicable area a, and can be formed with the drainage hole 17 having a perforated structure in the PE mounting part 13 and the rear portion 14 excluding the PE convex part 15 in the drainage hole applicable area a.

In particular, the drainage hole 17 can be classified into first and second drainage holes 17a and 17b located in the PE mounting part 13 and a third drainage hole 17c located in the rear portion 14, and each of the drainage holes 17a, 17b, and 17c can have various shapes that facilitate drainage.

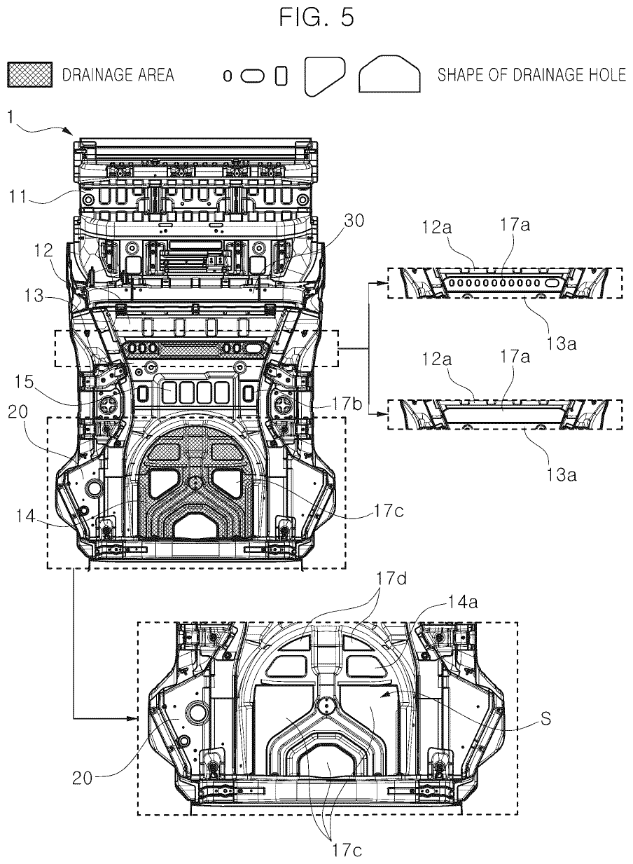

In addition to the first, second, and third drainage holes 17a, 17b, and 17c, the drainage hole 17 may further include a fourth drainage hole 17d (see FIG. 5) by changing the shape of the rear floor panel 10.

For example, the rear floor member 20 can have a substantially “H”-shaped frame structure and has front/rear longitudinal members (X-axis of XY coordinates) reinforced by a plurality of left/right transverse members (Y-axis of XY coordinates), which can surround the rear floor panel 10, and the quarter panel 40 can have a substantially “H”-shape frame structure and can have the front/rear longitudinal members reinforced by the left/right transverse members forming sidewalls to form a wheel house surrounding tires.

The upper member 30 can have a substantially “U”-shaped frame structure and left and right transverse members connecting front and rear longitudinal members forming the side walls can be added to the upper end of the rear floor panel 10 and fixed by welding.

The bed floor 50 can have a substantially rectangular plate structure to form the bed floor lower space S while covering the expected flooding area A.

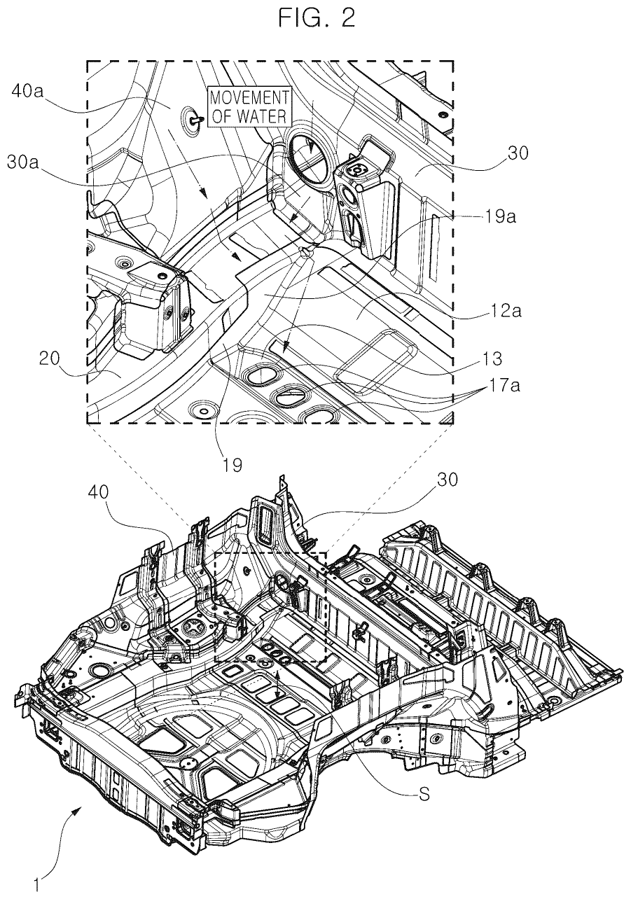

FIGS. 2 to 4 show an example in which the drainage structure for protecting the PE system can be set in the lower vehicle body 1.

Referring to FIG. 2, heights of the rear floor member 20, the upper member 30, and the quarter panel 40 can be all higher than that of the rear floor panel 10, and the rear floor member 20 (i.e., an upper end surface of the longitudinal member) and the upper member 30 can have an inclined surface for water to move toward the rear floor panel.

The rear floor panel 10 can include a sidewall upper extension 19a formed on the side flange 19 at the location of the extension surface 12a of the connection part 12, and the sidewall upper extension 19a surround a portion of the inclined surface (i.e., the inclined surface of the longitudinal member) of the rear floor member 20 located on a quarter panel sidewall part 40a of the quarter panel 40 to guide the movement of water.

The upper member 30 can form the inclined surface as an upper member lower extension 30a, and the upper member lower extension 30a can be located toward the sidewall upper extension 19a to guide the movement of water.

Therefore, in the drainage structure for protecting the PE system, the movement path of water in which water is collected by flowing along the extension surface 12a of the rear floor panel 10 at intersections at which the rear floor member 20, the upper member 30, and the quarter panel 40 all meet can be formed, and the water collected toward the PE mounting part 13 can drain to the outside using the first drainage hole 17a (and the second and third drainage holes 17b and 17c) as a water drainage path.

Referring to FIG. 3, the bed floor 50 can form the bed floor lower space S with respect to the upper surface of the rear floor panel 10 by being placed on an upper member flange 30-1 of the upper member 30 and a rear flange 14-1 (see FIG. 1) perpendicular at the rear portion 14 side of the rear floor panel 10, and the rear floor panel 10 can use the PE convex part 15 convex to the water blocking wall H with respect to the PE mounting part 13 as the drainage protection area B.

In particular, as in the K-K cross section, the PE convex part 15 can use the water blocking wall H convex to be higher than the PE mounting part 13 so that water may naturally flow down to the surrounding area of the PE convex part 15, which can effectively guide the movement of water to be directed to the drainage hole 17 according to the movement of the vehicle and gravity.

For example, the water blocking wall H can be an edge that forms the height of the PE convex part 15 and can have a structure in which three of the four surfaces of the edge are formed as a convex part edge inclined surface 15a to be directed to the front of the PE system 60, and the remaining one surface can be formed as a convex part rear inclined surface 15b to be directed to the rear of the PE system 60.

Therefore, the PE convex part 15 may retain a small amount of water, but allow the water to move to another area without stagnating due to the action of the convex part edge inclined surface 15a and the convex part rear inclined surface 15b.

Therefore, the water movement path can be such that the water flow through the extension surface 12a of the connection part 12 and the water flow through the convex part edge inclined surface 15a of the PE convex part 15 can be formed in opposite directions, and thus the front water movement path that allows water to be collected to the PE mounting part 13 and the rear water movement path that allows water through the convex part rear inclined surface 15b of the PE convex part 15 to be collected in the rear portion 14 can be formed in the front-rear direction of the drainage protection area B.

The water drainage path can include a front water drainage path through which the water collected in the PE mounting part 13 drains to the outside through the first and second drainage holes 17a and 17b and/or a rear water drainage path through which the water collected in the rear portion 14 drains to the outside through the third drainage hole 17c and can be formed in the front-rear direction of the drainage protection area B.

In particular, a height of the drainage protection area B can be formed to be higher than the height of the drainage area D by the water blocking wall H.

As described above, the drainage structure for protecting the PE system can be divided into a drainage guide area C and a drainage area D with respect to the drainage protection area B, and water falling onto the upper end surface of the quarter panel 40 or the rear floor member 20 may all be collected in the drainage area D through the drainage guide area C.

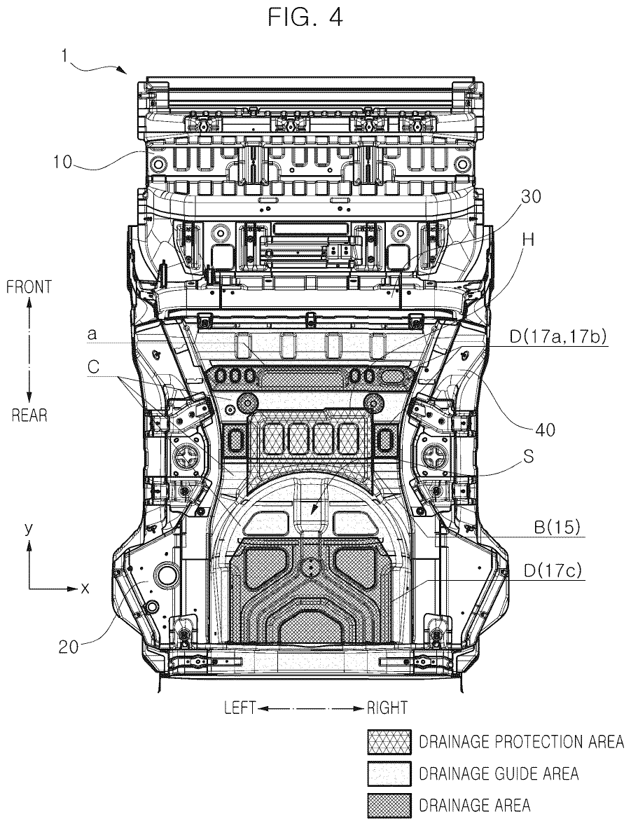

Referring to FIG. 4, an example in which the drainage protection area B, the drainage guide area C, and the drainage area D can be set on the rear floor panel 10 is disclosed.

For example, the drainage protection area B can be the PE convex part 15, the drainage guide area C can be an extension surface 12a of the connection part 12 and the PE mounting part 13 and the rear portion 14 excluding the PE convex part 15, and the drainage area D can be the first and second drainage holes 17a and 17b of the PE mounting part 13 and the third drainage hole 17c of the rear portion 14.

In particular, among the first and second drainage holes 17a and 17b, the first drainage hole 17a can be located at an interval from the PE mounting hole 16 in front of the PE convex part 15 (X-axis of XY coordinates), the second drainage hole 17b can be located at an interval from the convex part edge inclined surface 15a at the left and right sides (Y-axis of XY coordinates) of the PE convex part 15.

Therefore, the drainage protection area B can be an area that can prevent water from falling down the floor of the rear floor panel 10 and can protect the components of the PE system 60 located under the floor.

The drainage guide area C can serve to guide the water falling onto the rear floor panel 10 to move to the drainage area D.

The drainage area D can serve to drainage the water falling onto the rear floor panel 10 through the drainage hole 17.

FIG. 5 shows a structural modification of the rear floor panel 10 according to an application method of the drainage hole 17 for an embodiment. The drainage hole 17 can be formed in combination of circular, oval, rectangular, diamond, triangular and stepped shapes.

As shown, the rear floor panel 10 can use the PE mounting part 13 among the front portion 11, the connection part 12, the PE mounting part 13, and the rear portion 14 as it is or may be modified to the drainage type PE mounting part 13a or the drainage type rear portion 14a with the panel portion removed by changing the location and shape of the hole and the number of holes of the drainage hole 17 of the drainage area D according to a high drainage performance for the vehicle.

For example, the rear floor panel 10 can maintain the PE mounting part 13 as it is, and the first drainage hole 17a can maintain the location and shape of the hole as it is, and the number of holes arranged to be biased to left/right sides (Y-axis of XY coordinates) can be increased to the number of holes arranged uniformly in the entire section, thereby increasing drainage performance at the PE mounting part 13 side.

On the other hand, when the PE mounting part 13 of the rear floor panel 10 is changed to the drainage type PE mounting part 13a, the first drainage hole 17a can be formed as one drainage hole by removing the corresponding panel by perforating the entire section of the first drainage hole, thereby increasing drainage performance at the PE mounting part 13 side.

When the rear portion 14 of the rear floor panel 10 is changed to the drainage type rear portion 14a, the third drainage holes 17c symmetric in the left-right direction can be formed by removing the corresponding panel by perforating the entire section of the third drainage hole, and the fourth drainage hole 17d symmetric in the left-right direction can be further formed by removing the corresponding panel by perforating the panel portion above the third drainage hole 17c, thereby increasing drainage performance at the drainage type rear portion 14a side.

Therefore, the rear floor panel 10 may also reduce the weight of the panel by adopting the drainage type PE mounting part 13a and/or the drainage type rear portion 14a.

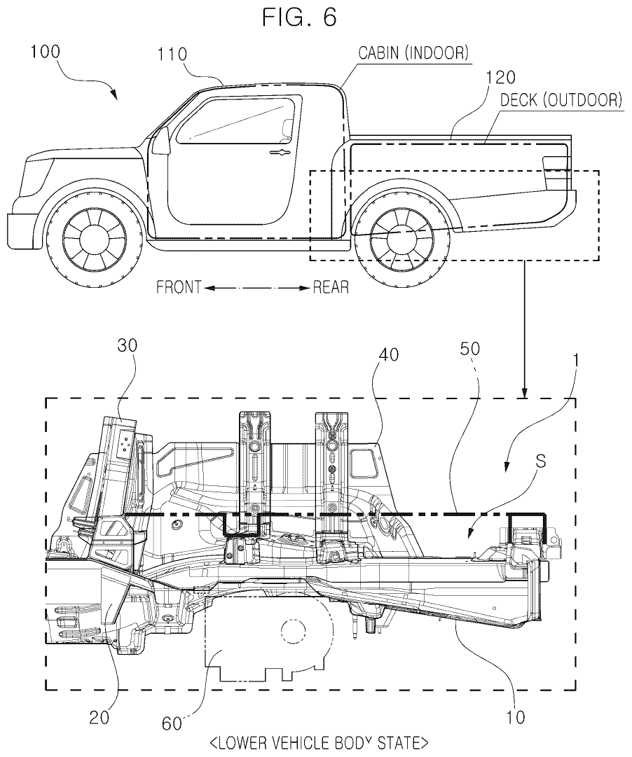

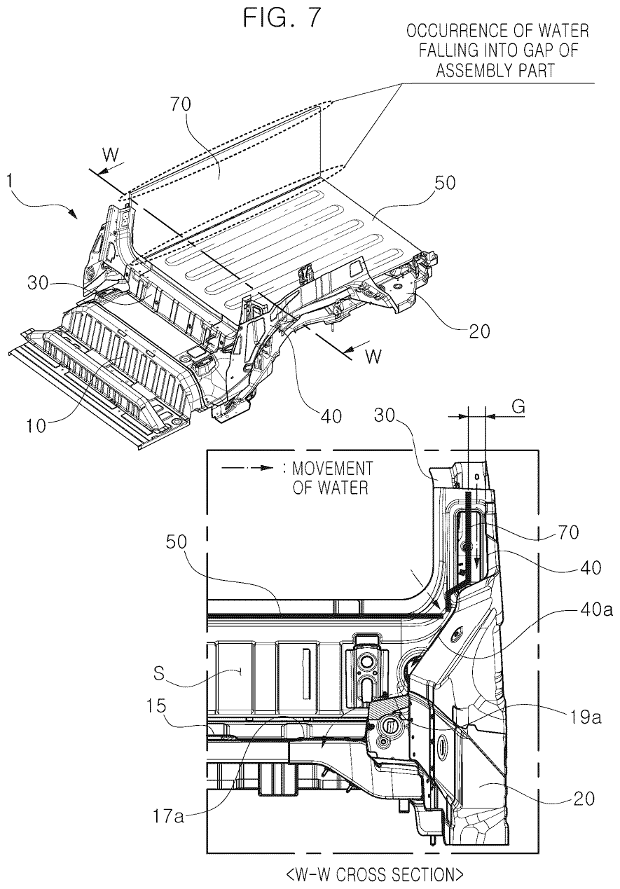

FIGS. 6 and 7 show a function of a drainage structure for protecting a PE system in a pickup vehicle 100 to which the lower vehicle body 1 is applied according to an embodiment of the present disclosure.

Referring to FIG. 6, a pickup vehicle 100 can be a pickup electric vehicle and can have a cabin 110 of the driver's seat, which is an indoor space, and a deck 120 of the cargo box, which is an outdoor space in which cargo may be loaded and transported, and the deck 120 can be formed as the lower vehicle body 1.

For example, because the lower vehicle body 1 can have the same configuration as the lower vehicle body 1 described in FIGS. 1 to 5, the rear floor panel 10 and the upper member 30 can separate the cabin 110 and the deck 120.

Referring to FIG. 7, a water drainage state in which the drainage structure for protecting the PE system in the pickup vehicle 100 is used is shown.

As shown, the deck 120 can form a floor with a bed floor 50 and sidewalls with bed side trims 70 added to both left and right sides of the quarter panel 40.

Like a W-W cross section, in the relationship between the rear floor panel 10 and the rear floor member 20, an upper end surface of the longitudinal member bonded to the sidewall upper extension 19a of the side flange 19 of the rear floor panel 10 and located outside the rear floor panel 10 of the rear floor member 20 can be directed to the PE mounting part 13 side of the rear floor panel 10 as a downward inclined surface at a location higher than one or more drainage areas D.

In the deck area in which the bed floor 50 can be located, a sidewall gap G between the bed floor 50 and the bed side trim 70 can be formed, and the sidewall gap G can act as a passage through which water is introduced when the vehicle enters a water puddle during traveling, in rainy weather, or during car washing, and thus the water may flow into the bed floor lower space S.

Therefore, when water falls from the bed floor 50 onto the rear floor member 20 through the sidewall gap G, the upper end surface of the rear floor member 20 can serve as the drainage guide area C to move water to the PE mounting part 13 that is the drainage area D.

As a result, because the water drains to the outside through the first drainage hole 17a of the PE mounting part 13, in the process of discharging the water to the outside, the PE system 60 can be located under the PE mounting part 13 is not affected by water.

As described above, in the lower vehicle body 1 having the drainage structure for protecting the PE system applied to the pickup vehicle 100 according to an embodiment of the present embodiment, the PE convex part 15 of the rear floor panel 10 forming the bed floor lower space S with the bed floor 50 can form the periphery of the PE system 60 as the drainage protection area B using the water blocking wall H, thereby preventing water from draining to a top portion of the PE system 60, in particular, preventing water from stagnating at a corner portion by a drainage protection area B and a drainage guide area C due to the prevention of the water drainage to the top portion of the PE system 60 and preventing water from flowing into the indoor and stagnating in the rear floor panel due to the water drainage to a lower end and sides of the bed floor by the drainage area D.

What is claimed is:

1. A lower vehicle body having a drainage structure for protecting a power electronics (PE) system, comprising:
a rear floor panel;
a bed floor coupled to an upper end of the rear floor panel to form a bed floor lower space; and
a PE convex part forming a periphery of the PE system located under the rear floor panel as a drainage protection area using a water blocking wall, wherein the water blocking wall is configured to direct water of the PE convex part to a drainage area of the rear floor panel at a protruding height higher than the drainage area.

2. The body of claim 1, wherein the water blocking wall is an edge forming a height of the PE convex part, wherein three surfaces of four surfaces of the edge are a convex part edge inclined surface and directed to a front of the PE system, and wherein a remaining one surface of the four surfaces is a convex part rear inclined surface and directed to a rear of the PE system.

3. The body of claim 2, wherein the rear floor panel has a drainage hole in the drainage area configured so that water drains to an outside of the rear floor panel.

4. The body of claim 3, wherein the rear floor panel divides the drainage area into a front drainage area on a PE mounting part and a rear drainage area on a rear portion with respect to the PE convex part.

5. The body of claim 4, wherein the rear floor panel forms a connection part with an extension surface connected to the PE mounting part, and wherein the extension surface has a downward inclined structure connected to the PE mounting part configured to direct the water.

6. The body of claim 5, wherein the rear floor panel forms the extension surface and the rear portion together with a surrounding section of the PE convex part as a drainage guide area.

7. The body of claim 6, wherein front inclined structures and a rear inclined structure are applied to the drainage guide area and configured so that the water flows to the drainage guide area through downward inclination.

8. The body of claim 7, wherein the front inclined structures are the extension surface of the connection part connected to the PE mounting part and the convex part edge inclined surface of the PE convex part.

9. The body of claim 7, wherein the rear inclined structure is part the convex part edge inclined surface of the PE convex part connected to a third drainage hole in the rear portion of the drainage hole.

10. The body of claim 1, wherein the rear floor panel is coupled to a rear floor member surrounding side portions of the rear floor panel under the rear floor panel,
wherein an upper member is located at an upper end of the rear floor panel, and
wherein a quarter panel is connected to a side portion of the rear floor member on a side surface of the rear floor panel.

11. The body of claim 10, wherein intersections at which the rear floor member, the upper member, and the quarter panel meet form an inclined surface at a higher location than the rear floor panel, and
wherein the inclined surface forms a water movement path configured so that through which the water is collected to the drainage area.

12. The body of claim 11, wherein the water movement path is connected to a sidewall upper extension extending from a side flange of the rear floor panel added to a longitudinal member of the rear floor member, and
wherein the sidewall upper extension is located on a longitudinal member side upper end surface of the rear floor member and a transverse member side upper member lower extension of the upper member.

13. The body of claim 1, wherein the rear floor panel is configured to change the drainage area using any one of a location and shape of a drainage hole and a number of drainage holes through which the water is discharged to an outside of the body.

14. The body of claim 13, wherein due to an increase in the number of drainage holes, an entire section of the drainage area is filled with the drainage hole.

15. The body of claim 13, wherein due to a modification of a shape of the drainage hole, an entire section of the drainage area is removed and formed as the drainage hole.

16. A pickup vehicle comprising:
a lower vehicle body having a drainage structure for protecting a power electronics (PE) system, wherein the lower vehicle body includes:
a rear floor panel on which the PE system is located on a PE block part,
a rear floor member surrounding side portions of the rear floor panel,
an upper member located at an upper end of the rear floor panel,
a quarter panel connected to a side portion of the rear floor member, and
a bed floor forming a bed floor lower space with the rear floor panel;
a cabin that is an indoor space; and
a deck that is an outdoor space forming a deck floor with the bed floor,
wherein a drainage guide area in a surrounding section and a drainage area in a front-rear section are set with respect to a drainage protection area of a PE convex part in the rear floor panel,
wherein an inclined surface is at an intersection at which the upper member and the quarter panel meet in the rear floor member, and
wherein the inclined surface is configured to be a movement path through which water introduced through the quarter panel is guided from the intersection to the drainage area.

17. The vehicle of claim 16, wherein the drainage area includes a plurality of drainage holes.

18. The vehicle of claim 16, wherein the rear floor panel and the upper member separate the cabin and the deck.

19. The vehicle of claim 16, wherein the quarter panel is coupled to a bed side trim covering side portions thereof and configured so that the water flows into a sidewall gap of the quarter panel and the bed side trim.

20. A lower vehicle body of a pickup vehicle having a drainage structure for protecting a power electronics (PE) system, comprising:
a rear floor panel;
a bed floor coupled to an upper end of the rear floor panel to form a bed floor lower space; and
a PE cover part of the PE system located under the rear floor panel, wherein the PE cover part forms part of the drainage structure configured to direct water on the PE cover part away from the PE system to a drainage area of the rear floor panel.
